(19) United States
(12) Patent Application Publication
(10) Pub. No.: US 2008/0300754 A1
(43) Pub. Date: Dec. 4, 2008

(54) Protecting systems for vehicles

(76) Inventor: Hsiu-Ping Lin, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/806,844

(22) Filed: Jun. 4, 2007

(51) Int. Cl. B60R 21/0132

(52) U.S. Cl. 701/46

(57) ABSTRACT

A protecting system for a vehicle includes a tilt-detecting module capable of detecting a tilt condition of the vehicle, an airbag capable of being inflated and expanding to cover an outer surface of the vehicle if the airbag is inflated; and an inflation module capable of generating a gas to inflate the airbag.

### BACKGROUND OF THE INVENTION

The present invention relates generally to protecting systems of vehicles, and more particularly, to a protecting system having an airbag capable of extending out of a surface of a vehicle when being inflated.

Airbags work with inflators and sensors applied as protecting devices may generally be used inside cars and may be capable of providing another level of protection to passengers of the cars in some car accidents. Also, some examples of the prior art to provide airbags on motorcycles are illustrated in some related U.S. patents such as U.S. Pat. No. 6,848,709 to Nagatsuyu, U.S. Pat. No. 7,029,029 to Yamazaki et. al., and U.S. Pat. No. 7,198,287 to Miyata, etc. The related U.S. patents disclose airbags designed to prevent serious injury by keeping riders' heads, chests or genitals from directly impacting steering wheels, dashboards, fuel tanks, or windshields of the motorcycles when the motorcycles are hit at front in motorcycle accidents. However, except being hit at front in a motorcycle accident, there may still be other kinds of reasons which may cause a motorcycle to be turned over or lie on a side of the motorcycle after hitting a ground, such as the motorcycle may be pushed or hit while being parked in a parking lot, on a road or at a parking space, or a tire of the motorcycle may suddenly lose its friction to the ground when advancing on a road and cause the motorcycle to slide down or be turned over. In addition to a rider of the motorcycle may be scraped, slashed or weighed by the motorcycle as the motorcycle's turning over, a damage of the motorcycle caused by turning over and hitting the ground may cost a lot of money for repairing the motorcycle. Furthermore, most of the airbags consistent with examples of the prior art may only be designed to be extended and protect the passengers when the sensors detect changes in velocities of the vehicle, or intensities of impacting forces caused by the accidents. It may be desirable to have a protecting system for a motorcycle capable of detecting the tilting of the motorcycle and inflating an airbag to protect the motorcycle or reduce the damage if the motorcycle is going to be turned over, hit the ground, or lie on a side, or to prevent a rider of the motorcycle from being weighed directly or scraped by the motorcycle or reduce the injury.

Moreover, to prevent a damage of the motorcycle caused by turning over or lying on a side, some examples of the prior art may provide a protruding material such as a frame slider or a prop attached at the motorcycle. When the motorcycle is turned over, the frame slider or the prop may touch the ground before the frame or other parts of the motorcycle on the side, thus may be capable of preventing or reducing damages of the frame or the other parts of the motorcycle in some level from hitting the ground directly. Moreover, the frame slider or the prop of the prior art may be capable of keeping a space between the motorcycle and the ground when the motorcycle lies on the side for preventing a rider from being weighed by the motorcycle. However, in one situation if the protruding material (the frame slider or the prop) is too big in size, it may not only influence an appearance of the motorcycle, but also lower down the safety of riding the motorcycle on a road or a street with heavy traffic, especially in rush hours. In another situation if the protruding material such (the frame slider or the prop) is too small, it may not be capable of providing enough protection to the motorcycle, furthermore, it may cause the motorcycle to be turned over again after the protruding material (the frame slider or the prop) impacts the ground. In both situations the protruding material (the frame slider or the prop) may not be capable of providing enough protection to the motorcycle or the rider. Moreover, the protruding material (the frame slider or the prop) itself may become a risk to the rider since the rider may be weighed by the motorcycle and the protruding material may stab or scrape the rider in a motorcycle accident. Also, the protruding material (the frame slider or the prop) may only capable of preventing or reducing the damage of the motorcycle if the motorcycle is turned over slowly. Once riding the motorcycle in a higher speed before sliding down or the motorcycle being hit and turned over rapidly, the protruding material (the frame slider or the prop) may not be capable of providing enough protection to the motorcycle or the rider, and even more it may also cause the motorcycle to be turned over again after the protruding material (the frame slider or the prop) impacts the ground. Also, since the protruding material (the frame slider or the prop) may usually keep a space between the motorcycle and the ground once the motorcycle lies on a side, but the space may not be large enough for the rider's legs or body, thus the rider may still get hurt because of being weighed or scraped by the motorcycle.

Therefore, it may be desirable to have a protecting system for a motorcycle capable of detecting the tilting of the motorcycle and providing a desired protection of the motorcycle or reducing the damage of the motorcycle, or preventing a rider of the motorcycle from being weighed directly by the motorcycle or reducing the injury of the rider, if the motorcycle is turned over while being parked or slides down while advancing on a road and going to be hit the ground and lie on a side of the motorcycle.

Moreover, a car with higher position of the center of gravity may also be turned over because of an accident or being driven on a road with rough or uneven road surface. In these situations, it may be desired to have a protecting system for the car to provide an external airbag for extending out of the car and impacting the ground before the car if the car is going to be turned over, hit the ground and lying on a side. The external airbag may prevent or reduce the damage of the car and may reduce the injury of the passenger or a person nearby the car in the accident.

Therefore, it may be desirable to have a protecting system for a vehicle that provides a desired protection of the vehicle or a passenger of the vehicle by providing an tilt-detecting module to control an airbag to be extended out of the vehicle if the vehicle is turned over and going to be hit the ground and lie on a side of the vehicle, and it may be capable of preventing or reducing the damage of the vehicle and the injury of the passenger in an accident.

### BRIEF SUMMARY OF THE INVENTION

Examples of the present invention may provide a protecting system for a vehicle. The protecting system may comprise a tilt-detecting module capable of detecting a tilt condition of the vehicle, an airbag capable of expanding the volume of the airbag and extending out of an outer surface of the vehicle if the airbag is inflated, and an inflation module capable of generating a gas and conducting the gas into the airbag to inflate the airbag.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a diagram illustrating a protecting system for a vehicle consistent with an example of the present invention;

FIG. 2 is a diagram illustrating a protecting system consistent with an example of the present invention;

FIG. 3 is a block diagram of a tilt-detecting module consistent with an example of the present invention;

FIG. 4 is a cross-sectional view of an airbag and an inflation module consistent with an example of the present invention;

FIG. 5 is a cross-sectional view of an airbag and an inflation module consistent with another example of the present invention;

FIG. 6A is a diagram illustrating an operation condition of a tilt condition measuring module and a comparing module consistent with an example of the present invention;

FIG. 6B is a diagram illustrating the operation of the tilt condition measuring module and the comparing module in FIG. 6A if the vehicle is turned over;

FIG. 7A is a diagram illustrating an operation condition of a tilt condition measuring module and a comparing module consistent with another example of the present invention;

FIG. 7B is a diagram illustrating the operation of the tilt condition measuring module and the comparing module in FIG. 7A if the vehicle is turned over;

FIG. 8A is a diagram illustrating an operation condition of a tilt condition measuring module and a comparing module consistent with still another example of the present invention;

FIG. 8B is a diagram illustrating the operation of the tilt condition measuring module and the comparing module in FIG. 8A if the vehicle is turned over;

FIG. 9 is a diagram illustrating an operation condition of a tilt condition measuring module and a comparing module consistent with yet another example of the present invention;

FIG. 10 is a diagram illustrating an operation condition of a tilt-detecting module consistent with still another example of the present invention;

FIG. 11 is a diagram illustrating a tilt-detecting module consistent with another example of the present invention;

FIG. 12 is a diagram illustrating a tilt-detecting module consistent with still another example of the present invention;

FIG. 13 is a diagram illustrating a tilt-detecting module consistent with yet another example of the present invention;

FIG. 14 is a diagram illustrating a tilt-detecting module consistent with still another example of the present invention; and

FIG. 15 is a diagram illustrating a tilt-detecting module consistent with yet another example of the present invention.

### DETAILED DESCRIPTION OF THE PREFERRED EMBODIMENT

Reference will now be made in detail to the present embodiments of the invention, examples of which are illustrated in the accompanying drawings. Wherever possible, the same reference numbers will be used throughout the drawings to refer to the same or like parts.

FIG. 1 is a diagram illustrating a protecting system 102 for a vehicle 100 consistent with an example of the present invention. Referring to FIG. 1, the protecting system 102 may comprise a tilt-detecting module 104, an airbag 106, and an inflation module 108. The tilt-detecting module 104 may be capable of detecting a tilt condition (not shown in FIG. 1) of the vehicle 100. The airbag 106 may be capable of expanding the volume of the airbag 106 and extending out of an outer surface 110 of the vehicle 100 if the airbag 106 is inflated. The inflation module 108 may be capable of generating a gas (not shown in FIG. 1) and conducting the gas into the airbag 106 to inflate the airbag 106.

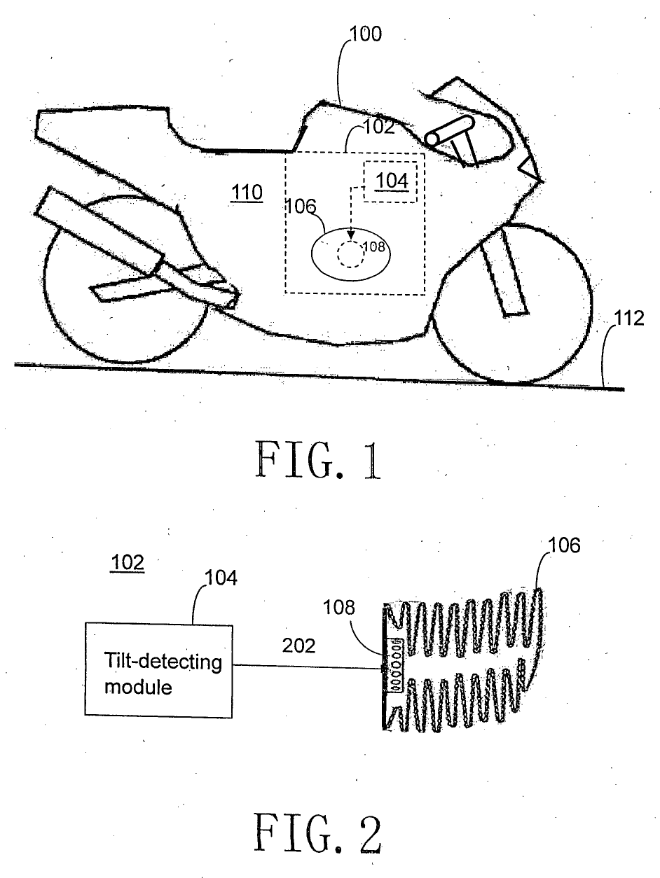

FIG. 2 is a diagram illustrating the protecting system 102 consistent with an example of the present invention. Referring to FIG. 2, the protecting system 102 may comprise the tilt-detecting module 104, the airbag 106, and the inflation module 108. The tilt-detecting module 104 may be capable of generating an inflation signal 202, and the inflation module 108 may be capable of inflating the airbag 106 if the inflation module 108 receives the inflation signal 202.

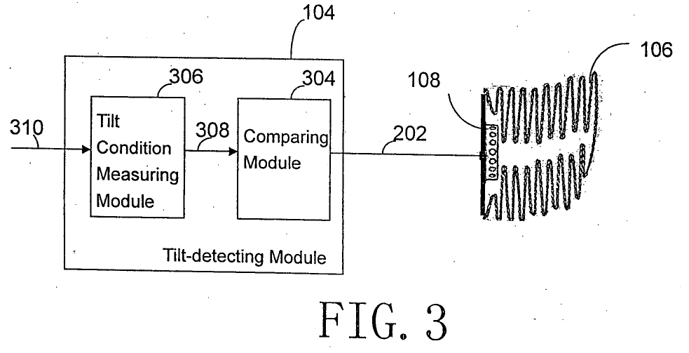

FIG. 3 is a block diagram of the tilt-detecting module 102 consistent with an example of the present invention. Referring to FIG. 3, the tilt-detecting module 102 may comprise a tilt condition measuring module 306 and a comparing module 304. The tilt condition measuring module 306 may be capable of measuring the tilt condition 310 of the vehicle 100 respected to a ground 112 to generate a tilt condition measuring result 308. The comparing module 304 may be capable of receiving the tilt condition measuring result 308, comparing the tilt condition measuring result 308 and a tilting limitation (not shown in FIG. 3), and generating the inflation signal 202 if the tilt condition measuring result 308 achieves or exceeds the tilting limitation.

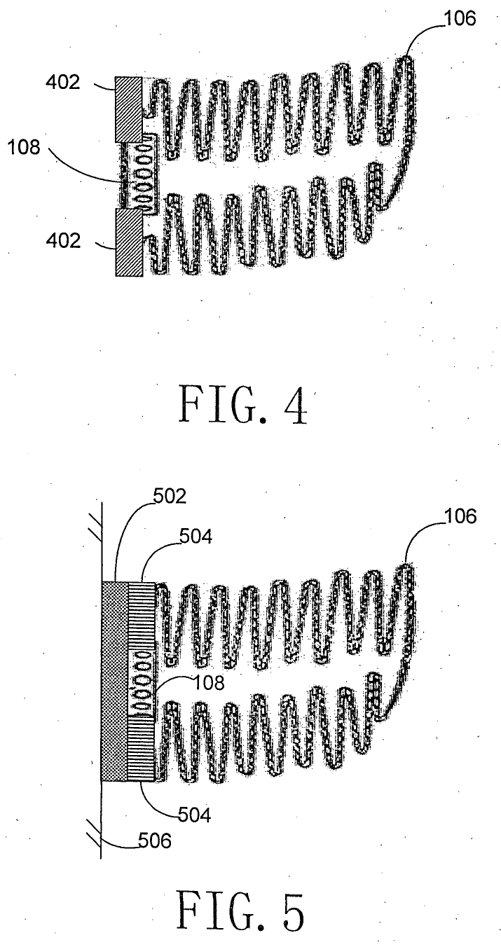

FIG. 4 is a cross-sectional view of the airbag 106 and the inflation module 108 consistent with an example of the present invention. Referring to FIG. 4, the inflation module may comprise a first switching module 402. The first switching module 402 may be capable of connecting to the airbag 106 or separating from the airbag 106, thus the first switching module 402 may be capable of connecting the airbag 106 to the first switching module 402 to connect the airbag 106 to the inflation module 108 or separating the airbag 106 from the first switching module 402 to separate the airbag 106 from the inflation module 108. Moreover, the first switching module 402 may be used if for a reason, the airbag 106 may need to be replaced by another airbag.

FIG. 5 is a cross-sectional view of the airbag 106 and the inflation module 108 consistent with another example of the present invention. Referring to FIG. 5, the protecting system 102 may further comprise a second switching module 502. The second switching module 502 may be capable of connecting to the airbag 106, the inflation module 108 and the vehicle 100, or separating the airbag 106 and the inflation module 108 from the vehicle 100. Moreover, the second switching module 502 may be used if for a reason, the airbag 106 or the inflation module 108 may need to be replaced by another airbag or another inflation module. In one example, the protecting system 102 may further comprise a third switching module 504. The third switching module 504 may be capable of connecting the airbag 106 to the inflation module 108 or separating the airbag 106 from the inflation module 108, and the third switching module 504 may be used if for a reason, the airbag 106 may need to be replaced by another airbag.

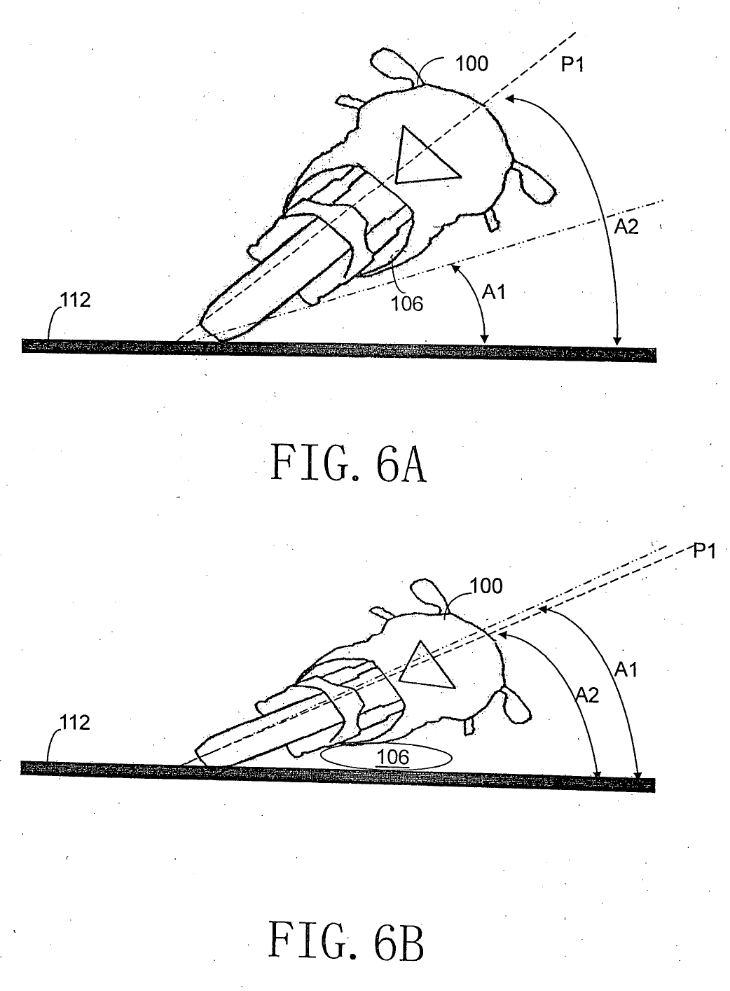

FIG. 6A is a diagram illustrating an operation condition of the tilt condition measuring module 306 and the comparing module 304 consistent with an example of the present invention, and FIG. 6B is a diagram illustrating the operation of the tilt condition measuring module 306 and the comparing module 304 in FIG. 6A if the vehicle 100 is turned over. Referring to FIG. 6A, the tilt condition measuring result 308 (shown in FIG. 3) may comprise an included angle A2 formed between a cross-section plane P1 of the vehicle 100 and the ground 112 and measured by the tilt condition measuring module 308, the tilting limitation may comprise a minimum included angle A1, and the comparing module 304 may compare the included angle A2 and the minimum included angle A1 and generate the inflation signal 202 if the included angle A2 is smaller than or equal to the minimum included angle A1. As shown in FIG. 6B, the inflation module 108 may receive the inflation signal 202, generate a gas and conduct the gas into the airbag 106 to inflate the airbag 106. As being inflated, the airbag 106 may be extended out of the outer surface 110 and touch the ground 112 before the vehicle 100, thus may prevent or reduce the damage of the vehicle 100 from hitting the ground 112 directly.

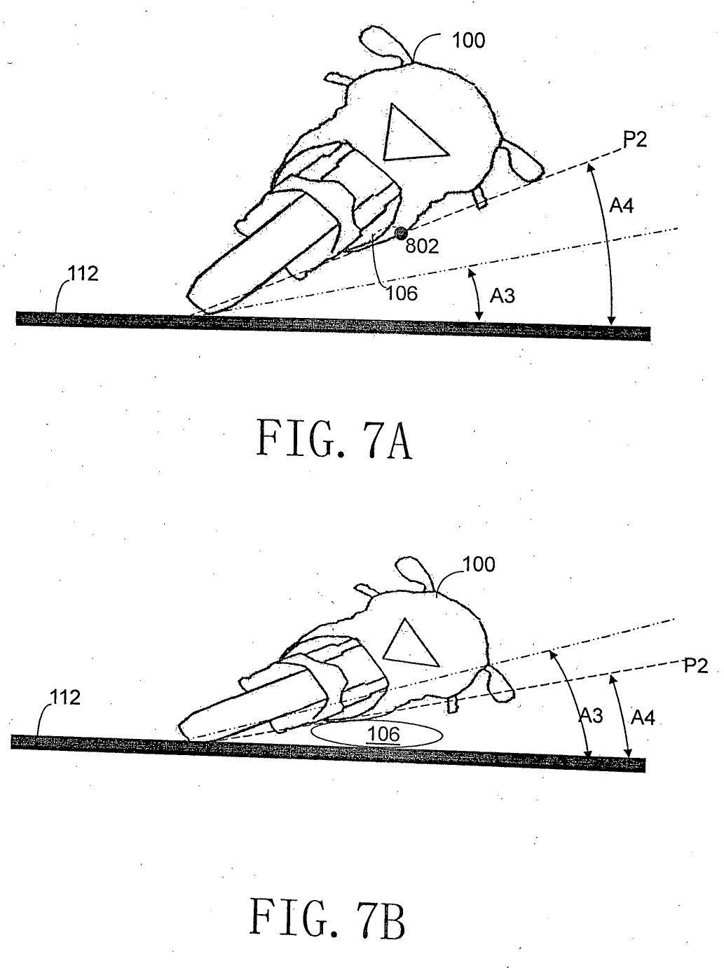

FIG. 7A is a diagram illustrating an operation condition of the tilt condition measuring module 306 and the comparing module 304 consistent with an example of the present invention, and FIG. 7B is a diagram illustrating the operation of the tilt condition measuring module 306 and the comparing module 304 in FIG. 7A if the vehicle 100 is turned over. Referring to FIG. 7A, the tilt condition measuring result 308 (shown in FIG. 3) may comprise an included angle A4 formed between a tangent plane P2 passed through a point 802 on the outer surface 110 of the vehicle 100 and the ground 112 and measured by the tilt condition measuring module 308, the tilting limitation may comprise a minimum included angle A3, and the comparing module 304 may compare the included angle A4 and the minimum included angle A3 and generate the inflation signal 202 if the included angle A4 is smaller than or equal to the minimum included angle A3. As shown in FIG. 7B, the inflation module 108 may receive the inflation signal 202, generate a gas and conduct the gas into the airbag 106 to inflate the airbag 106. As being inflated, the airbag 106 may be extended out of the outer surface 110 and touch the ground 112 before the vehicle 100, thus may prevent or reduce the damage of the vehicle 100 from hitting the ground 112 directly.

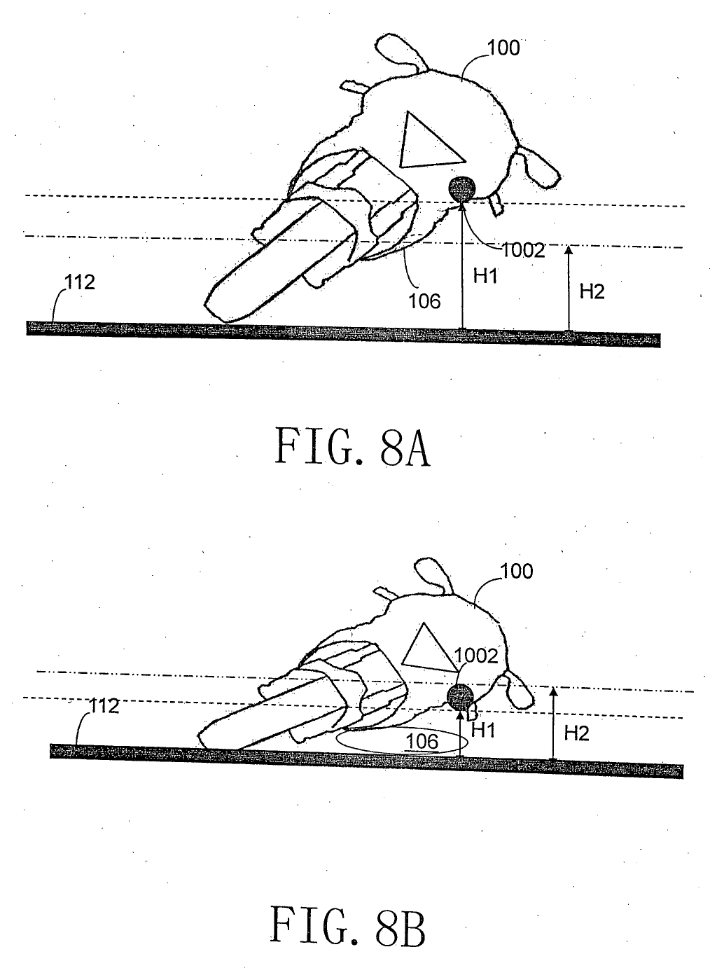

FIG. 8A is a diagram illustrating an operation condition of the tilt condition measuring module 306 and the comparing module 304 consistent with still another example of the present invention, and FIG. 8B is a diagram illustrating the operation of the tilt condition measuring module 306 and the comparing module 304 in FIG. 8A if the vehicle 100 is turned over. Referring to FIG. 8A, the tilt condition measuring result 308 (shown in FIG. 3) may comprise a distance HI between a point 1002 on the outer surface 110 of the vehicle 100 and the ground 112 and measured by the tilt condition measuring module 306, the tilting limitation may comprise a minimum distance H2, and the comparing module 304 may compare the distance H1 and the minimum distance H2 and generate the inflation signal 202 if the distance H1 is smaller than or equal to the minimum distance H2. As shown in FIG. 8B, the inflation module 108 may receive the inflation signal 202, generate a gas and conduct the gas into the airbag 106 to inflate the airbag 106. As being inflated, the airbag 106 may be extended out of the outer surface 110 and touch the ground 112 before the vehicle 100, thus may prevent or reduce the damage of the vehicle 100 from hitting the ground 112 directly.

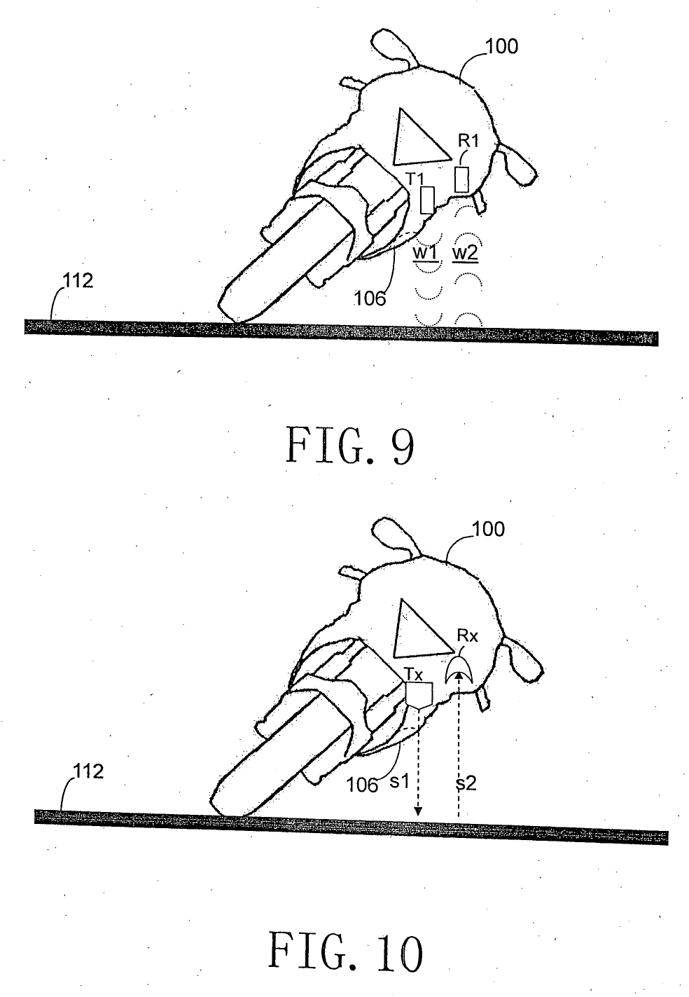

FIG. 9 is a diagram illustrating an operation condition of the tilt condition measuring module 306 and the comparing module 304 consistent with yet another example of the present invention. Referring to FIG. 9, the tilt condition measuring module 306 may comprise an emitting module T1, a receiving module R1 and an intensity measuring module (not shown in FIG. 9). The emitting module T1 may be capable of emitting an electromagnetic wave w1 to the ground 112, and the electromagnetic wave w1 may be reflected by the ground 112 to form a reflected electromagnetic wave w2. The receiving module R1 may be capable of receiving the reflected electromagnetic wave w2, and the intensity measuring module may be capable of measuring an intensity (not shown in FIG. 9) of the reflected electromagnetic wave w2. The tilting limitation may comprise a maximum intensity (not shown in FIG. 9), and the comparing module 304 may compare the intensity and the maximum intensity and generate the inflation signal 202 if the intensity is stronger than or equal to the maximum intensity.

In one example, the protecting system may further comprise a setting module (not shown). The setting module may be capable of setting the tilting limitation.

It will be appreciated by those skilled in the art that the tilt condition measuring modules and the comparing modules consistent with the examples illustrated above may also be capable of forming another tilt-detecting module by combining at least two kinds of the tilt condition measuring modules and the comparing modules for generating the inflation signal 202 if the tilt condition achieves or exceeds the tilting limitation.

FIG. 10 is a diagram illustrating an operation condition of the tilt-detecting module 104 consistent with still another example of the present invention. Referring to FIG. 10, the tilt-detecting module 104 may comprise a signal-transmitting module Tx, a signal-receiving module Rx and a comparing module (not shown in FIG. 10). The signal-transmitting module Tx may be formed at the vehicle 100 and capable of generating a first digital signal (not shown in FIG. 10) and processing the first digital signal to generate an emitting signal s1 and emitting the emitting signal s1 to the ground 112. The emitting signal s1 may be reflected by the ground 112 to generate a reflected signal s2. The signal-receiving module Rx may be formed at the vehicle 100. The signal-receiving module Rx may be capable of receiving the reflected signal s2 and processing the reflecting signal s2 to generate a second digital signal (not shown in FIG. 10). The comparing module may be capable of comparing the first digital signal and the second digital signal and generating the inflation signal 202 to the inflation module 108 to make the inflation module 108 inflate the airbag 106 if a difference (not shown) between the first digital signal and the second digital signal is smaller than or equal to a minimum comparing difference (not shown). In one example, the emitting signal s1 may be a radio frequency (RF) signal and the signal-receiving module Rx may comprise a Radio Frequency Identification (RFID) module capable of making radio frequency identification. In another example, the signal-transmitting module Tx may be capable of processing the first digital signal by an encoding process to make the emitting signal s1 be unique to the vehicle 100, and the emitting signal s1 of the vehicle 100 may not be capable of being identified by another signal-receiving module formed at another vehicle to make a comparing module of the vehicle to generate an inflation signal. Moreover, in another example, the signal-receiving module Rx may be capable of processing the reflected signal s2 by a decoding process respected to the encoding process to generate the second digital signal.

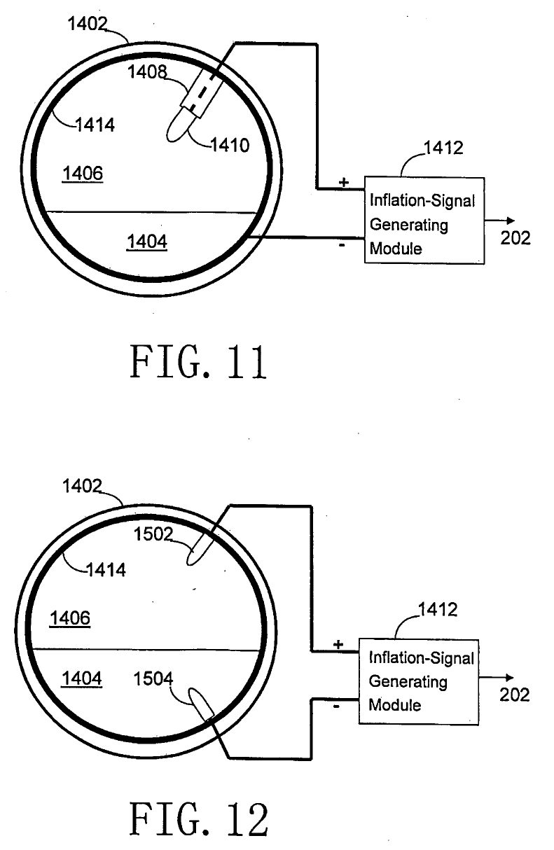

FIG. 11 is a diagram illustrating the tilt-detecting module 104 consistent with another example of the present invention. Referring to FIG. 11, the tilt-detecting module 104 may comprise a container 1402, a liquid material 1404, a base 1408, an electrode 1410 and an inflation-signal generating module 1412. The container 1402 may be hollow and comprise an interior wall 1414 formed by a material having the electric conductivity. The interior wall 1414 may form a cavity (not numbered) in the container 1402. The liquid material 1404 may have the electric conductivity and exist in the cavity to flow accordingly to the tilt condition of the vehicle 100. The liquid material 1404 may occupy only a part of the cavity to keep a space 1406 not being occupied by the liquid material 1404 in the cavity. The position of the space 1406 may be changed accordingly to the liquid material 1404 as the liquid material 1404 flows accordingly to the tilt condition of the vehicle 100. The base 1408 may comprises an isolating material and be formed at a position (not numbered) on the interior wall 1414, wherein a part (not numbered) of the base 1408 may be electrically isolated from the interior wall 1414. The base 1408 may exist in the space 1406 if the tilt condition does not achieve or exceed a tilting limitation. The electrode 1410 may be formed at the part of the base 1408 and electrically isolated from the interior wall 1414, the electrode 1410 may exist in the space 1406 if the tilt condition does not achieve or exceed the tilting limitation. The inflation-signal generating module 1412 may be electrically coupled to the interior wall 1414 and the electrode 1410 separately. The inflation-signal generating module 1412 may be capable of generating the inflation signal 202 to the inflation module 108 to make the inflation module 108 inflate the airbag 106 if the tilt condition achieves or exceeds the tilting limitation to make the liquid material 1404 touch the electrode 1410 and form a current (not shown in FIG. 11) to flow through the interior wall 1414 and the electrode 1410. It will be appreciated by those skilled that the position of the inflation-signal generating module 1412 may also be capable of being formed inside the container 1402, thus the position of the inflation-signal generating module 1412 is not limited to the present invention.

FIG. 12 is a diagram illustrating the tilt-detecting module 104 consistent with still another example of the present invention. Referring to FIG. 12, the tilt-detecting module 104 may comprise a container 1402, a liquid material 1404, a first electrode 1502, a second electrode 1504 and an inflation-signal generating module 1412. The container 1402 may be hollow and comprises an interior wall 1414. The interior wall 1414 may be electrically isolating and may form a cavity (not numbered) in the container 1402. The liquid material 1404 may have the electric conductivity and exist in the cavity to flow accordingly to the tilt condition of the vehicle 100. The liquid material 1404 may occupy only a part of the cavity to keep a space 1406 not to be occupied by the liquid material 1404 in the cavity. The position of the space 1406 may be changed accordingly to the liquid material 1404 as the liquid material 1404 flows accordingly to the tilt condition. The first electrode 1502 may be formed at a first position (not numbered) on the interior wall 1414, and the second electrode 1504 may be formed at a second position (not numbered) on the interior wall 1414 other than the first position on the interior wall 1414. Moreover, at least one of the first electrode 1502 and the second electrode 1504 may exist in the space 1406 if the tilt condition does not achieve or exceed a tilting limitation. In this example, the first electrode 1502 is in the space 1406. The inflation-signal generating module 1412 may be electrically coupled to the first electrode 1502 and the second electrode 1504 separately. The inflation-signal generating module 1412 may be capable of generating the inflation signal 202 to the inflation module 108 to make the inflation module 108 inflate the airbag 106 if the tilt condition achieves or exceeds the tilting limitation to make the liquid material 1404 touch the first electrode 1502 and the second electrode 1504 at the same time to form a current (not shown in FIG. 12) to flow through the first electrode 1502 and the second electrode 1504. It will be appreciated by those skilled that the position of the inflation-signal generating module 1412 may also be capable of being formed inside the container 1402, thus the position of the inflation-signal generating module 1412 is not limited to the present invention.

In another example (not shown in the drawings), the tilt-detecting module 104 may comprise a container being hollow and comprising an interior wall formed by a material having the electric conductivity. The interior wall may form a cavity in the container. The liquid material may have the electric conductivity and exist in the cavity to flow accordingly to the tilt condition of the vehicle. The liquid material may occupy only a part of the cavity to keep a space not being occupied by the liquid material in the cavity. The position of the space may be changed accordingly to the liquid material as the liquid material flows accordingly to the tilt condition of the vehicle. The base may comprises an isolating material and be formed at a position on the interior wall. A part of the base may be electrically isolated from the interior wall. The base may exist in the liquid material if the tilt condition does not achieve or exceed a tilting limitation. The electrode may be formed on the part of the base and electrically isolated from the interior wall. The electrode may exist in the liquid material if the tilt condition does not achieve or exceed the tilting limitation. The inflation-signal generating module may be electrically coupled to the interior wall and the electrode separately. The inflation-signal generating module may be capable of generating a current to flow through the interior wall and the electrode if the tilt condition does not achieve or exceed the tilting limitation, and the inflation-signal generating module may be capable of generating the inflation signal 202 to the inflation module 108 to make the inflation module 108 inflate the airbag 106 if the tilt condition achieves or exceeds the tilting limitation to make the liquid material separated from the electrode to stop the current.

In yet another example (not shown in the drawings), the tilt-detecting module may comprise a container, a liquid material, a first electrode, a second electrode and an inflation-signal generating module. The container may be hollow and comprise an interior wall. The interior wall may be electrically isolating and form a cavity in the container. The liquid material may have the electric conductivity and exist in the cavity to flow accordingly to the tilt condition of the vehicle. The liquid material may occupy only a part of the cavity to keep a space not being occupied by the liquid material in the cavity. The position of the space may be changed accordingly to the liquid material as the liquid material flows accordingly to the tilt condition. The first electrode may be formed at a first position on the interior wall. The second electrode may be formed at a second position on the interior wall other than the first position on the interior wall. the liquid material touches the first electrode and the second electrode if the tilt condition does not achieve or exceed a tilting limitation. The inflation-signal generating module may be electrically coupled to the first electrode and the second electrode separately. The inflation-signal generating module may be capable of generating a current to flow through the first electrode and the second electrode if the tilt condition does not achieve or exceed the tilting limitation. The inflation-signal generating module may be capable of generating the inflation signal 202 to the inflation module 108 to make the inflation module 108 inflate the airbag 106 if the tilt condition achieves or exceeds the tilting limitation to make the liquid material separated from the first electrode or the second electrode to stop the current.

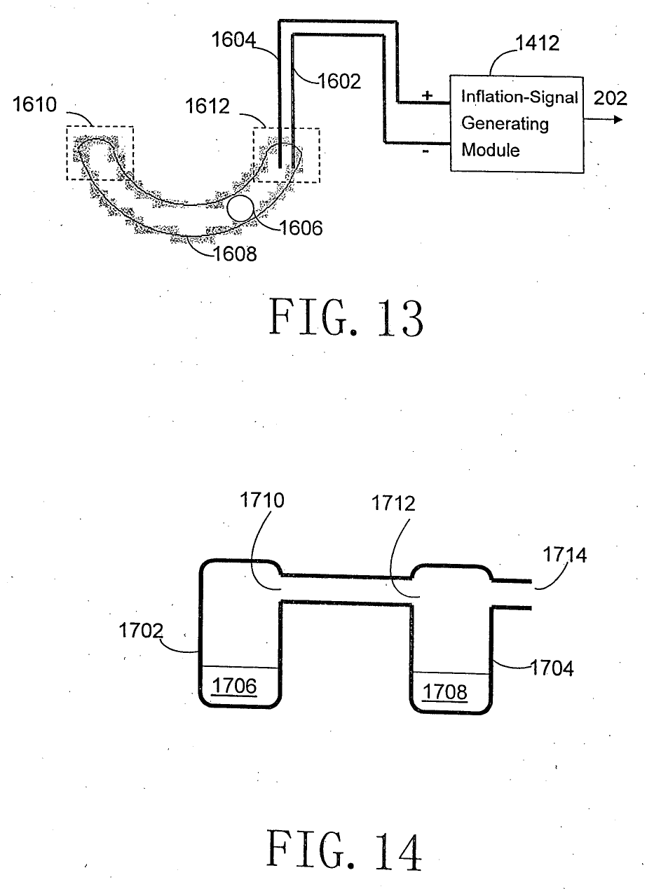

FIG. 13 is a diagram illustrating the tilt-detecting module 104 consistent with yet another example of the present invention. Referring to FIG. 13, the tilt-detecting module 104 may comprise a tube 1608, a material 1606, a first electrode 1602 and a second electrode 1604 and an inflation-signal generating module 1412. The tube 1608 may be hollow and formed by an electrically isolating material. The tube 1608 may comprise a first end 1610 and a second end 1612. The material 1606 may have the electric conductivity and formed in the tube 1608 to move in the tube 1608 accordingly to the tilt condition of the vehicle 100. The material 1606 may occupy only a part of the space in the tube 1608. Both of the first electrode 1602 and the second electrode 1604 may be formed at one or both of the first end 1610 and the second end 1612 of the tube 1608. In this example, the first electrode 1602 and the second electrode 1604 are formed at the second end 1612 of the tube 1608. Both of the first electrode 1602 and the second electrode 1604 may not be touched by the material 1606 if the tilt condition does not achieve or exceed a tilting limitation. The inflation-signal generating module 1412 may be electrically coupled to the first electrode 1602 and the second electrode 1604 separately. The inflation-signal generating module 1412 may be capable of generating the inflation signal 202 to the inflation module 108 to make the inflation module 108 inflate the airbag 106 if the tilt condition achieves or exceeds the tilting limitation to make the material 1606 touch the first electrode 1602 and the second electrode 1604 at the same time to generate a current (not shown) to flow through the first electrode 1602 and the second electrode 1604. It will be appreciated by those skilled that the position of the inflation-signal generating module 1412 may also be capable of being formed inside the tube 1608, thus the position of the inflation-signal generating module 1412 is not limited to the present invention.

In still another example (not shown in the drawings), since the vehicle 100 may comprise a first wheel and a second wheel, and the first wheel may comprise a first tire and the second wheel may comprise a second tire, the tilt-detecting module 104 may comprise a first tire-pressure gauge, a second tire-pressure gauge, and an inflation-signal generating module. The first tire-pressure gauge may be capable of detecting a variation of the tire pressure in the first tire and generating a first tire-pressure variation value. The second tire-pressure gauge may be capable of detecting a variation of the tire-pressure in the second tire and generating a second tire-pressure variation value. The inflation-signal generating module may be capable of generating the inflation signal 202 to the inflation module 108 to make the inflation module 108 inflate the airbag 106 if the first tire-pressure variation value achieves or exceeds a first tire-pressure setting value and the second tire-pressure variation value achieves or exceeds a second tire-pressure setting value, since once the vehicle 100 is turned over, the tire pressures of the first tire and the second tire of the vehicle may vary because of leaving the ground 112.

In yet another example (not shown in the drawings), the tilt-detecting module 104 may comprise a sensor formed on a protruding part of the vehicle 100. The tilt-detecting module 104 may be capable of generating the inflation signal 202 to the inflation module 108 to make the inflation module 108 inflate the airbag 106 if the protruding module touch the ground 112. The protruding part of the vehicle 100 may comprise a frame slider, a prop, a steering handle, a reversing mirror, a bulge at the outer surface 110 or a footrest such that if the vehicle 100 is turned over, the protruding part may be the first part of the vehicle 100 to touch the ground 112.

FIG. 14 is a diagram illustrating the tilt-detecting module 104 consistent with still another example of the present invention. Referring to FIG. 14, the tilt-detecting module 104 may comprise a first container 1702, a second container 1704, a first chemical material 1706 and a second chemical material 1708. The first container 1702 may comprise a first open end 1710. The second container 1704 may comprise a second end 1712. The first chemical material 1706 may exist in the first container 1702 if the tilt condition does not achieve or exceed a tilting limitation. The first chemical material 1706 may be capable of moving accordingly to the tilt condition of the vehicle 100 and may move out of the first container 1702 through the first open end 1710 if the tilt condition achieves or exceeds the tilting limitation. The second chemical material 1708 may exist in the second container 1704 and be capable of interacting with the first chemical material 1706 to generate the gas (not shown in FIG. 14). The gas may be capable of spurting out of the second container 1704 (through a third open end 1714) and being conducted to inflate the airbag 106. Moreover the first chemical material 1706 and the second chemical material 1708 may be separated from each other if the tilt condition does not achieve or exceed the tilting limitation, and the first chemical material 1706 and the second chemical material 1708 may be capable of interacting with each other if the tilt condition achieves or exceeds the tilting limitation to make the first chemical material 1706 move out of the first container 1702 through the first open end 1710 and into the second container 1704 through the second open end 1712 to interact with the second material 1708. In another example, the tilt-detecting module 104 may further comprise a third container (not shown). The first chemical material 1706 and second chemical material 1708 may be capable of moving into the third container to generate the gas if the tilt condition achieves or exceeds the tilting limitation.

FIG. 15 is a diagram illustrating the tilt-detecting module 104 consistent with yet another example of the present invention. Referring to FIG. 15, the tilt-detecting module 104 may comprise a container 1800, a first chemical material 1806, and a second chemical material 1808. The container 1800 may comprise a first part 1802 and a second part 1804. The first chemical material 1806 may exist in the first part 1802 of the container 1800 if the tilt condition does not achieve or exceed a tilting limitation. The first chemical material 1806 may be capable of moving accordingly to the tilt condition of the vehicle 100 and moving into the second part 1804 of the container 1800 if the tilt condition achieves or exceeds the tilting limitation. The second chemical material 1808 may exist in the second part 1804 of the container 1800 and be capable of interacting with the first chemical material 1806 to generate the gas (not shown in FIG. 15) to inflate the airbag 106, The first chemical material 1806 and the second chemical material 1808 may be separated from each other if the tilt condition does not achieve or exceed the tilting limitation, and the first chemical material 1806 and the second chemical material 1808 may be capable of interacting with each other if the tilt condition achieves or exceeds the tilting limitation to make the first chemical material 1806 move into the second part 1804 of the container 1800 to interact with the second material 1808. In one example, the first part 1802 and the second part 1804 may be separated.

It will also be appreciated by those skilled in the art that the tilt-detecting modules consistent with the examples illustrated above may also be capable of forming another tilt-detecting module by combining at least two kinds of the tilt-detecting modules for generating the inflation signal 202.

In another example, the tilt-detecting module 104 may be formed at the vehicle 100 or a remote place other than the vehicle 100.

In yet another example, the tilt-detecting module 104 may be formed at a remote place other than the vehicle 100 and the inflation signal 202 may be transferred to the inflation module 108 through a wireless communication way.

In one example, the protecting system 102 may further comprise a first switch (not shown in the drawings), wherein the airbag 106 may not capable of expanding the volume of the airbag 106 and extend out of the outer surface 110 of the vehicle 100 if the first switch is turned off.

In another example, the protecting system 102 may further comprise a second switch (not shown in the drawings). The inflation module 108 may inflate the airbag 106 directly to make the airbag 106 expand the volume of the airbag 106 and extend out of the surface 110 of the vehicle 100 if the second switch is turned on.

In other example, the vehicle 102 may comprise a car or a motorcycle.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A protecting system for a vehicle, the protecting system comprising:
a tilt-detecting module capable of detecting a tilt condition of the vehicle;
an airbag capable of being inflated and expanding to cover an outer surface of the vehicle if the airbag is inflated; and
an inflation module capable of generating a gas to inflate the airbag.

2. The protecting system of claim 1, wherein the tilt-detecting module comprises:
a tilt condition measuring module capable of measuring the tilt condition of the vehicle respected to a ground to generate a tilt condition measuring result; and
a comparing module capable of comparing the tilt condition measuring result and a tilting limitation, and generating an inflation signal to the inflation module to make the inflation module inflate the airbag if the tilt condition measuring result achieves or exceeds the tilting limitation.

3. The protecting system of claim 1, wherein the inflation module comprises:
a first switching module capable of connecting to the airbag or separating from the airbag, the first switching module being capable of connecting the airbag to the first switching module to connect the airbag to the inflation module or separating the airbag from the first switching module to separate the airbag from the inflation module.

4. The protecting system of claim 1, further comprises:
a second switching module capable of connecting to the airbag, the inflation module and the vehicle, or separating the airbag and the inflation module from the vehicle.

5. The protecting system of claim 2, wherein the tilt condition measuring result comprises an included angle formed between a cross-section plane of the vehicle and the ground and measured by the tilt condition measuring module, wherein the tilting limitation comprises a minimum included angle, and the comparing module compares the included angle and the minimum included angle and generates the inflation signal if the included angle is smaller than or equal to the minimum included angle.

6. The protecting system of claim 2, wherein the tilt condition measuring result comprises an included angle formed between a tangent plane passing through a point on an outer surface of the vehicle and the ground and measured by the tilt condition measuring module, wherein the tilting limitation comprises a minimum included angle, and the comparing module compares the included angle and the minimum included angle and generates the inflation signal if the included angle is smaller than or equal to the minimum included angle.

7. The protecting system of claim 2, wherein the tilt condition measuring result comprises a distance between a point on an outer surface of the vehicle and the ground and measured by the tilt condition measuring module, wherein the tilting limitation comprises a minimum distance, and the comparing module compares the distance and the minimum distance and generates the inflation signal if the distance is smaller than or equal to the minimum distance.

8. The protecting system of claim 2, wherein the tilt condition measuring module comprises:
an emitting module capable of emitting an electro-magnetic wave to the ground, wherein the electro-magnetic wave being reflected by the ground to form a reflected electro-magnetic wave;
a receiving module capable of receiving the reflected electro-magnetic wave; and
an intensity measuring module capable of measuring the intensity of the reflected electro-magnetic wave,
wherein the tilting limitation comprises a maximum intensity limitation, and the comparing module compares the intensity of the reflected electro-magnetic wave and the maximum intensity limitation and generates the inflation signal if the intensity of the reflected electro-magnetic wave is stronger than or equal to the maximum intensity limitation.

9. The protecting system of claim 2, further comprises a setting module capable of setting the tilting limitation.

10. The protecting system of claim 1, wherein the tilt-detecting module is formed, disposed or attached at the vehicle or a remote place other than the vehicle.

11. The protecting system of claim 2, wherein the tilt-detecting module is formed, disposed or attached at a remote place other than the vehicle and the inflation signal is transferred to the inflation module through a wireless communication.

12. The protecting system of claim 1, further comprises a first switch, wherein the airbag is not capable of being inflated if the first switch is turned off.

13. The protecting system of claim 1, further comprises a second switch, wherein the inflation module inflates the airbag if the second switch is turned on.

14. The protecting system of claim 1, wherein the vehicle is a car, a motorcycle or a bicycle.

15. The protecting system of claim 1, wherein the tilt-detecting module comprises:
a signal-transmitting module formed, disposed or attached at the vehicle and capable of generating a first digital signal, processing the first digital signal to generate an emitting signal and emitting the emitting signal to a ground, wherein the emitting signal being reflected by the ground to generate a reflected signal;
a signal-receiving module formed, disposed or attached at the motorcycle, the signal-receiving module being capable of receiving the reflected signal and processing the reflected signal to generate a second digital signal; and
a comparing module capable of comparing the first digital signal and the second digital signal and generating an inflation signal to the inflation module to make the inflation module inflate the airbag if a difference between the first digital signal and the second digital signal is smaller than or equal to a minimum comparing difference.

16. The protecting system of claim 15, wherein the emitting signal comprise a radio frequency (RF) signal and the signal-receiving module comprises a Radio Frequency Identification (RFID) module capable of making radio frequency identification.

17. The protecting system of claim 1, wherein the tilt-detecting module comprises:
a container being hollow and comprising an interior wall formed by a material having electric conductivity, wherein the interior wall forms a cavity in the container;
a liquid material having electric conductivity and existing in the cavity to flow according to the tilt condition of the vehicle, the liquid material occupying only a part of the cavity to keep a space not being occupied by the liquid material in the cavity, wherein a position of the space in the cavity is changed accordingly to the liquid material as the liquid material flows accordingly to the tilt condition of the vehicle;
a base comprising an insulating material and formed, disposed or attached at a position on the interior wall, wherein a part of the base is electrically insulated from the interior wall and the base exists in the space if the tilt condition does not achieve or exceed a tilting limitation;
an electrode formed, disposed or attached at the part of the base and electrically insulated from the interior wall, the electrode existing in the space if the tilt condition does not achieve or exceed the tilting limitation; and
an inflation-signal generating module electrically coupled to the interior wall and the electrode separately, the inflation-signal generating module being capable of generating an inflation signal to the inflation module to make the inflation module inflate the airbag if the tilt condition achieves or exceeds the tilting limitation to make the liquid material touch the electrode and generate a current to flow through the interior wall and the electrode.

18. The protecting system of claim 1, wherein the tilt-detecting module comprises:
a container being hollow and comprising an interior wall, wherein the interior wall is electrically insulating and forms a cavity in the container;
a liquid material having electric conductivity and existing in the cavity to flow accordingly to the tilt condition of the vehicle, the liquid material occupying only a part of the cavity to keep a space not being occupied by the liquid material in the cavity, wherein a position of the space being changed accordingly to the liquid material as the liquid material flows accordingly to the tilt condition;
a first electrode formed, disposed or attached at a first position on the interior wall;
a second electrode formed, disposed or attached at a second position on the interior wall other than the first position on the interior wall,
wherein at least one of the first electrode and the second electrode exists in the space if the tilt condition does not achieve or exceed a tilting limitation; and
an inflation-signal generating module electrically coupled to the first electrode and the second electrode separately, the inflation-signal generating module being capable of generating an inflation signal to the inflation module to make the inflation module inflate the airbag if the tilt condition achieves or exceeds the tilting limitation to make the liquid material touch the first electrode and the second electrode at the same time to generate a current to flow through the first electrode and the second electrode.

19. The protecting system of claim 1, wherein the tilt-detecting module comprises:
a container being hollow and comprising an interior wall formed by a material having electric conductivity, wherein the interior wall formsing a cavity in the container;
a liquid material having electric conductivity and existing in the cavity to flow accordingly to the tilt condition of the vehicle, the liquid material occupying only a part of the cavity to keep a space not being occupied by the liquid material in the cavity, wherein a position of the space being changed accordingly to the liquid material as the liquid material flows accordingly to the tilt condition of the vehicle;
a base comprising an insulating material and formed, disposed or attached at a position on the interior wall, wherein a part of the base is electrically insulated from the interior wall, the base existing in the liquid material if the tilt condition does not achieve or exceed a tilting limitation;
an electrode formed, disposed or attached on the part of the base and electrically insulated from the interior wall, the electrode existing in the liquid material if the tilt condition does not achieve or exceed the tilting limitation; and
an inflation-signal generating module electrically coupled to the interior wall and the electrode separately, the inflation-signal generating module being capable of generating a current to flow through the interior wall and the electrode if the tilt condition does not achieve or exceed the tilting limitation, and the inflation-signal generating module being capable of generating an inflation signal to the inflation module to make the inflation module inflate the airbag if the tilt condition achieves or exceeds the tilting limitation to make the liquid material be separated from the electrode to stop the current.

20. The protecting system of claim 1, wherein the tilt-detecting module comprises:
a container being hollow and comprising an interior wall, wherein the interior wall is electrically insulating and forms a cavity in the container;
a liquid material having the electric conductivity and existing in the cavity to flow accordingly to the tilt condition of the vehicle, the liquid material occupying only a part of the cavity to keep a space not being occupied by the liquid material in the cavity, wherein a position of the space being changed accordingly to the liquid material as the liquid material flows accordingly to the tilt condition;
a first electrode formed, disposed or attached at a first position on the interior wall;
a second electrode formed, disposed or attached at a second position on the interior wall other than the first position on the interior wall,
wherein the liquid material touches the first electrode and the second electrode at the same time if the tilt condition does not achieve or exceed a tilting limitation; and
an inflation-signal generating module electrically coupled to the first electrode and the second electrode separately, the inflation-signal generating module being capable of generating a current to flow through the first electrode and the second electrode if the tilt condition does not achieve or exceed the tilting limitation, and the inflation-signal generating module being capable of generating an inflation signal to the inflation module to make the inflation module inflate the airbag if the tilt condition achieves or exceeds the tilting limitation to make the liquid material separated from the first electrode or the second electrode to stop the current.

21. The protecting system of claim 1, wherein the tilt-detecting module comprises:
a tube being hollow and formed by an electrically isolating material, the tube comprising a first end and a second end;
a material having electric conductivity and disposed in the tube to move in the tube accordingly to the tilt condition of the vehicle, the material occupying only a part of the space in the tube;
a first electrode and a second electrode, wherein both of the first electrode and the second electrode are formed or disposed at one or both of the first end and the second end of the tube,
wherein the both of the first electrode and the second electrode being touched by the material at the same time if the tilt condition achieves or exceeds a tilting limitation; and
an inflation-signal generating module electrically coupled to the first electrode and the second electrode separately, the inflation-signal generating module being capable of generating an inflation signal to the inflation module to make the inflation module inflate the airbag if the tilt condition achieves or exceeds the tilting limitation to make the material touch the first electrode and the second electrode at the same time to generate a current to flow through the first electrode and the second electrode.

22. The protecting system of claim 1, wherein the vehicle comprises a first wheel and a second wheel, the first wheel comprises a first tire, the second wheel comprisesing a second tire, and the tilt-detecting module comprises:
a first tire-pressure gauge capable of detecting a first variation of the tire pressure of the first tire and generating a first tire-pressure variation value;
a second tire-pressure gauge capable of detecting a second variation of the tire-pressure of the second tire and generating a second tire-pressure variation value; and
an inflation-signal generating module capable of generating an inflation signal to the inflation module to make the inflation module inflate the airbag if the first tire-pressure variation value achieves or exceeds a first tire-pressure setting value and the second tire-pressure variation value achieves or exceeds a second tire-pressure setting value.

23. The protecting system of claim 1, wherein the tilt-detecting module comprises:
a sensor formed, disposed or attached on a protruding part of the vehicle and capable of generating an inflation signal to the inflation module to make the inflation module inflate the airbag if the protruding module touch a ground.

24. The protecting system of claim 1, wherein the tilt-detecting module comprises:
a first container comprising a first open end;
a second container comprising a second end;
a first chemical material existing in the first container if the tilt condition does not achieve or exceed a tilting limitation, the first chemical material being capable of moving accordingly to the tilt condition of the vehicle and moving out of the first container through the first open end if the tilt condition achieves or exceeds the tilting limitation;
a second chemical material existing in the second container and capable of interacting with the first chemical material to generate the gas to inflate the airbag,
wherein the first chemical material and the second chemical material are separated from each other if the tilt condition does not achieve or exceed the tilting limitation, and the first chemical material and the second chemical material are capable of interacting with each other if the tilt condition achieves or exceeds the tilting limitation to make the first chemical material move out of the first container through the first open end and move into the second container through the second open end to interact with the second material.

25. The protecting system of claim 1, wherein the tilt-detecting module comprises:
a container comprising a first part and a second part;
a first chemical material existing at the first part of the container if the tilt condition does not achieve or exceed a tilting limitation, the first chemical material being capable of moving accordingly to the tilt condition of the vehicle and moving to the second part of the container if the tilt condition achieves or exceeds the tilting limitation; and
a second chemical material existing at the second part of the container and capable of interacting with the first chemical material to generate the gas to inflate the airbag,
wherein the first chemical material and the second chemical material are separated from each other if the tilt condition does not achieve or exceed the tilting limitation, and the first chemical material and the second chemical material are capable of interacting with each other if the tilt condition achieves or exceeds the tilting limitation to make the first chemical material move into the second part of the container to interact with the second material.
